(19) United States
(12) Patent Application Publication
(10) Pub. No.: US 2014/0360204 A1
(43) Pub. Date: Dec. 11, 2014

(54) Systems and Methods for Power Plants

(71) Applicant: Srinivas N. Moorkanikkara, Pittsburgh, PA (US)

(72) Inventor: Srinivas N. Moorkanikkara, Pittsburgh, PA (US)

(21) Appl. No.: 14/279,095

(22) Filed: May 15, 2014

Related U.S. Application Data
(60) Provisional application No. 61/832,059, filed on Jun. 6, 2013.

(51) Int. Cl. F01K 23/10; F02C 6/06

(52) U.S. Cl. CPC F01K 23/10; F02C 6/06
USPC 60/783; 60/670; 60/648; 60/784

(57) ABSTRACT

The present techniques are directed to systems and a method for extracting a high pressure gas from a power plant. A method includes providing a fuel to a burner, and providing an oxidant to the burner, wherein an oxidant flow rate is adjusted to provide a substantially stoichiometric ratio of the oxidant to the fuel. The fuel and the oxidant are combusted in the burner to produce an exhaust gas. At least a portion of the exhaust gas is extracted downstream of the burner to form a product gas.

### CROSS REFERENCE TO RELATED APPLICATIONS

This application claims the priority benefit of U.S. Patent Application 61/832,059 filed Jun. 6, 2013 entitled SYSTEMS AND METHODS FOR POWER PLANTS, the entirety of which is incorporated by reference herein.

### FIELD OF THE INVENTION

The present disclosure relates generally to low-emission power generation systems. More particularly, the present disclosure relates to systems and methods for removing a high pressure product gas stream from a burner or combustor in a power plant.

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

The combustion of fuel within a burner or combustor, e.g., integrated with a gas turbine, can be controlled by monitoring the temperature of the exhaust gas. In a combustor associated with a gas turbine, the amount of fuel introduced to a number of combustors can be adjusted to hold a desired combustion gas or exhaust gas temperature. Conventional combustion turbines control the oxidant introduced to the combustors using inlet guide vanes. At partial load, the amount of oxidant introduced to the combustor is reduced and the amount of fuel introduced is again controlled to reach the desired exhaust gas temperature. At partial load, the efficiency of gas turbines drops because the ability to reduce the amount of oxidant is limited by the inlet guide vanes, which are only capable of slightly reducing the flow of oxidant. Further, the oxidant remains at a constant lower flow rate when the inlet guide vanes are in their flow restricting position. The efficiency of the gas turbine then drops when it is at lower power production because to make that amount of power with that mass flow a lower expander inlet temperature is required. Moreover, existing oxidant inlet control devices may not allow fine flow rate control and may introduce large pressure drops with any restriction on the oxidant flow. With either of these approaches to oxidant control, there are potential problems with lean blow out at partial load or reduced pressure operations.

Controlling the amount of oxidant introduced to the combustor can be desirable when an objective is to capture carbon dioxide (CO₂) from the exhaust gas. Current carbon dioxide capture technology is expensive due to several reasons. One reason is the low pressure and low concentration of carbon dioxide in the exhaust gas. The carbon dioxide concentration, however, can be significantly increased from about 4% to greater than 10% by operating the combustion process under substantially stoichiometric conditions. Further, a portion of the exhaust gas may be recycled to the combustor as a diluent in order to control the temperature of the exhaust gas. Also, any unused oxygen in the exhaust gas may be a contaminate in the captured carbon dioxide, restricting the type of solvents that can be utilized for the capture of carbon dioxide.

In many systems, an oxidant flow rate may be reduced by altering the operation of a separate oxidant system. For example, an independent oxidant compressor may be throttled back to a slower operating speed thereby providing a decreased oxidant flow rate. However, the reduction in compressor operating speed generally decreases the efficiency of the compressor. Additionally, throttling the compressor may reduce the pressure of the oxidant entering the combustor. In contrast, if the oxidant is provided by the compressor section of the gas turbine, reducing the speed is not a variable that is controllable during power generation. Gas turbines that are used to produce 60 cycle power are generally run at 3600 rpm. Similarly, to produce 50 cycle power the gas turbine is often run at 3000 rpm. In conventional gas turbine combustor operations, the flow of oxidant into the combustor may not warrant significant control because the excess oxidant is used as diluent in the combustion chamber to control the combustion conditions and the temperature of the exhaust gas. A number of studies have been performed to determine techniques for controlling combustion processes in gas turbines.

For example, U.S. Pat. No. 6,332,313 to Willis et al. discloses a combustion chamber with separate valved air mixing passages for separate combustion zones. A combustion chamber assembly includes a primary, a secondary and a tertiary fuel and air mixing ducts to supply fuel and air to each of primary, secondary and tertiary combustion zones, respectively. Each of the primary, secondary and tertiary fuel and air mixing ducts includes a pair of axial flow swirlers, which are arranged coaxially to swirl the air in opposite directions and fuel injectors to supply fuel coaxially to the respective axial flow swirlers. Valves are provided to control the supply of air to the primary and the secondary fuel and air mixing ducts, respectively. A duct is arranged to supply cooling air and dilution air to the combustion chamber. The amount of air supplied to the primary, secondary and tertiary fuel and air mixing ducts and the duct is measured.

International Patent Application Publication No. WO/2010/044958 by Mittricker et al. discloses methods and systems for controlling the products of combustion, for example, in a gas turbine system. One embodiment includes a combustion control system having an oxygenation stream substantially comprising oxygen and CO₂ and having an oxygen to CO₂ ratio, then mixing the oxygenation stream with a combustion fuel stream and combusting in a combustor to generate a combustion products stream having a temperature and a composition detected by a temperature sensor and an oxygen analyzer, respectively. The data from the sensors are used to control the flow and composition of the oxygenation and combustion fuel streams. The system may also include a gas turbine with an expander having a load and a load controller in a feedback arrangement.

Generally, past efforts to decrease emissions and capture CO₂ for further use or sequestration have focused on gas turbine generation systems. These efforts have used a recycled exhaust stream to cool a combustor. A portion of the stream is diverted to maintain mass balance in the recycle stream. However, the recycle stream is decompressed, cooled, and then recompressed along with the rest of the exhaust stream, lowering the efficiency of the system.

### SUMMARY

An embodiment described herein provides a power plant. The power plant includes an oxidant system configured to provide a high pressure oxidant stream, and a fuel system including a high pressure fuel stream. A burner is configured to combust the high pressure oxidant stream with the high pressure fuel stream to produce a high pressure exhaust gas. A product gas system is configured to extract at least a portion of the high pressure exhaust gas to form a product gas, and a recycle system is configured to return a portion of the high pressure exhaust gas to the burner as a diluent.

Another embodiment provides a gas turbine system that includes an oxidant system that is configured to provide a high pressure oxidant stream. The gas turbine system includes a fuel system that is configured to provide a high pressure fuel stream. A combustor is configured to combust the high pressure oxidant stream with the high pressure fuel stream to produce a high pressure exhaust gas. An expander turbine is configured to be driven by the high pressure exhaust stream, generating mechanical energy and a low pressure exhaust stream. A product gas system is disposed between the combustor and the expander turbine, wherein the product gas system is configured to extract at least a portion of the high pressure exhaust gas to form a product gas.

A method of extracting a high pressure gas from a power plant. The method includes providing a fuel to a burner, and providing an oxidant to the burner, wherein an oxidant flow rate is adjusted to provide a substantially stoichiometric ratio of the oxidant to the fuel. The fuel and the oxidant are combusted in the burner to produce an exhaust gas. At least a portion of the exhaust gas is extracted downstream of the burner and before any other equipment to form a product gas.

### BRIEF DESCRIPTION OF THE DRAWINGS

The advantages of the present techniques are better understood by referring to the following detailed description and the attached drawings, in which:

FIG. 1 is a schematic diagram of a power generation system that allows for a direct recapture and recycle of gas from a burner or combustor;

FIG. 2 is a schematic diagram of a gas turbine generator in which at least a portion of the high pressure exhaust gases from a number of combustors bypasses an expander turbine;

FIG. 3 is a schematic diagram of a gas turbine generator (GTG) illustrating a control system operative to enable a portion of the high pressure exhaust gases from the combustors to bypass the expander turbine;

FIG. 4 is a schematic of a gas turbine system with a dual exhaust system;

FIG. 5 is a block diagram of a method for operating a power plant to remove at least a portion of gases from a burner prior to an expander turbine; and

FIG. 6 is a block diagram of a plant control system that may be used to control a power plant that is configured to remove a portion of the exhaust gas immediately after a burner or combustor.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

### OVERVIEW

Embodiments of the present invention provide a system and a method for harvesting a product gas from a power generation burner while maintaining the pressure of the gas. The burner may be a combustor on a gas turbine generator or a burner used in a conventional Rankine cycle power plant. The power plant may use sensors to individually control a number of burners in the power plant, while recycling an exhaust gas to the burner.

The control may be based, at least in part, on measurements from sensors, for example, located in a ring on an exhaust expander in a gas turbine generator. The sensors may include mass flow sensors, oxygen sensors, carbon monoxide sensors, and temperature sensors, among others. Further, combinations of different types of sensors may be used to provide further information.

The use of individually controlled burners may increase the burn efficiency of a power plant, for example, by making the burn closer to a one-to-one equivalence ratio. Such improvements in efficiency may lower O₂ and unburned hydrocarbons in the exhaust, make capturing CO₂ from the exhaust gas more efficient. This may improve the capture of the CO₂ for use in enhanced oil recovery, CO₂ sequestration, and other purposes.

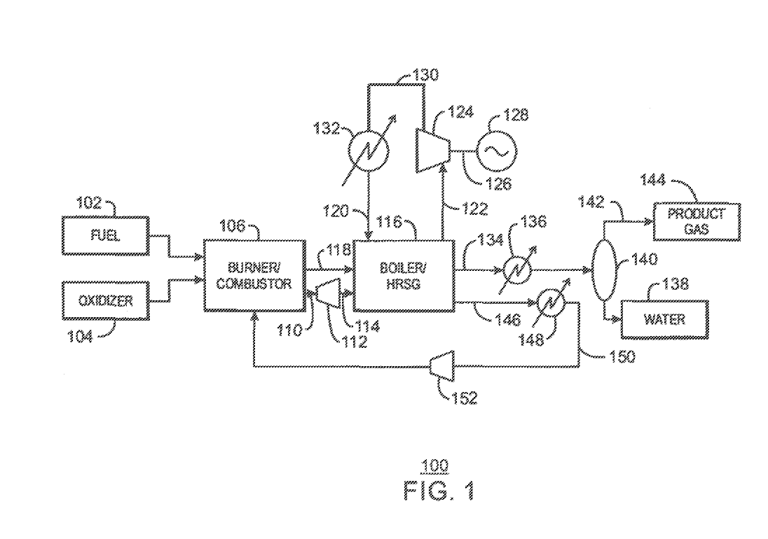

FIG. 1 is a schematic diagram of a power generation system 100 that allows for a direct recapture and recycle of gas from a combustor. In the power generation system 100, a fuel stream 102 and an oxidant stream 104 are fed to a burner/combustor 106 for combustion. The fuel stream 102 may include methane or other gaseous or liquid hydrocarbons. In some embodiments, coal may be used, for example, if the burner/combustor 106 is used in a

Rankine cycle plant. The oxidant stream 104 can be air, oxygen, or other oxygenates. The use of substantially pure oxygen from a gas separation process may allow for a much higher temperature burn, for example, in a stoichiometric ratio between the oxidant stream 104 and fuel stream 102, while decreasing or even eliminating the production of NOₓ. A recycle stream 108, which may be a processed exhaust gas, may also be fed to the burner/combustor 106, for example, to cool the burner/combustor 106 and downstream systems, allowing the burner/combustor 106 to be run at a stoichiometric ratio without temperatures causing damage.

A hot combustion stream 110 from the burner/combustor 106 can be used to drive an expander turbine 112. The exhaust stream 114 from the expander turbine 112 may then be directed to a boiler/HRSG (heat recovery steam generator) 116. In an embodiment, a hot combustion stream 118 can be directly sent from the burner/combustor 106 to the boiler/HRSG 116, for example, through a separated zone from the lower pressure exhaust stream 114, allowing the hot combustion stream 118 to remain at a high pressure for use as a product or recycle stream.

In the boiler/HRSG 116, the heat from the combustion gases 114 and 118 is used to boil a water stream 120 to create a steam stream 122. The steam stream 122 can be used to drive an expander turbine 124 to create mechanical energy 126. The mechanical energy 126 can be used to drive a generator 128 for the production of electricity. A low pressure steam stream 130 can be passed through a heat exchanger 132 to be condensed, providing a major portion of the water stream 120.

From the boiler/HRSG 116, a high pressure exhaust stream 134 can be passed through a heat exchanger 136 to condense out water 138 from the combustion, which can be removed in a separation vessel 140. A resulting high pressure stream 142 may be used as a product gas 144, for example, in enhanced oil recovery. In some embodiments, a portion of the product gas 144 may be recycled as a cooling gas, or injected into a spent reservoir for sequestration of CO₂. The amount of the hot combustion stream 118 that is removed directly from the burner/combustor 106 may be matched to the amount of fuel and oxidizer that is combusted to assist with mass balance of the system.

In the boiler/HRSG 116, the lower pressure exhaust stream 114 from the expander turbine 112 is cooled to form a low pressure recycle stream 146. As mentioned, the boiler/HRSG 116 can be separated into high pressure and low pressure zones for each of the two combustion gas streams 118 and 114. The low pressure recycle stream 146 can be passed through a heat exchanger 148 for cooling and to condense out water formed in the combustion, forming a recycle stream 150. The pressure of the recycle stream 150 can be boosted in a compressor 152, forming the recycle stream 108.

The drawing of FIG. 1 is not intended to indicate that the power generation system 100 is to include all of the components shown in FIG. 1. Further, any number of additional components may be included within the power generation system 100, depending on the details of the specific implementation. For example, the power generation system 100 may include any suitable types of compressors and valves for controlling the fuel stream 102 and oxidizer stream 104, among others.

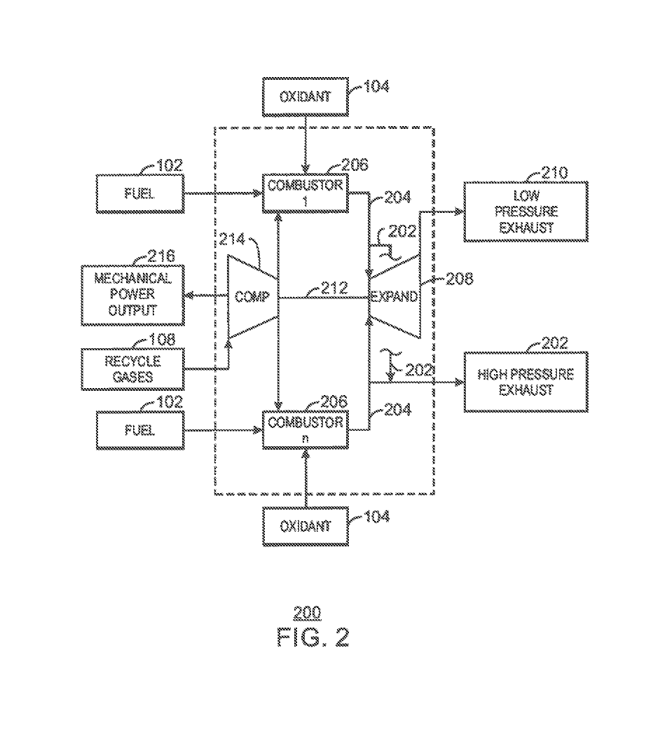

FIG. 2 is a schematic diagram of a gas turbine generator 200 in which at least a portion 202 of the high pressure exhaust gases 204 from a number of combustors 206 bypasses an expander turbine 208. Like numbered items are as discussed with respect to FIG. 1. In embodiments, the gas turbine generator 200 has a number of combustors 206 that combust the fuel stream 102 with the oxidant stream 104. For example, a gas turbine generator 200 may have 2, 4, 6, 14, 18, or even more combustors 206, depending on the size of the gas turbine generator 200.

The oxidant stream 104 may be provided to each of the combustors 206 from various sources. For example, in embodiments, an external oxidant source, such as an external compressor, may provide the oxidant stream 104 to the combustors 206.

After the portion 202 of the high pressure exhaust gases 204 bypasses the expander turbine 208, the remainder of the high pressure exhaust gases 204 can be used to drive the expander turbine 208, resulting in a low pressure exhaust gas 210. The gas turbine generator 200 may have a single shaft 212 coupling the turbine expander 208 to a compressor 214. However, the gas turbine generator 200 is not limited to a single shaft arrangement, as multiple shafts could be used, generally with mechanical linkages or transmissions between shafts.

The high pressure exhaust gases 204 from the combustors 206 expand in the turbine expander 208, creating mechanical energy 216. The mechanical energy may power the compressor 214 through the shaft 212. Further, a portion of the mechanical energy may be harvested from the gas turbine as a mechanical power output 216, for example, to generate electricity or to power oxidant compressors. The low pressure exhaust gas 210 may be vented, used for heat recovery, recycled to the compressor 214, or used in any combinations thereof.

Removing at least a portion 202 of the high pressure exhaust gas 204 directly from the combustors 206 allows that gas to be used for further processing without a drop in pressure and a corresponding need for recompression. By comparison, if all of the high pressure exhaust gases 204 were to be flowed through the expander turbine 208, recompression of the gas before removal from the process could provide a net energy loss, depending on process efficiency. In one embodiment, all of the high pressure exhaust gases 204 may be sent directly to downstream systems without passing through an expander turbine 208, for example, if the system were to be used in a normal Rankine cycle power system.

The drawing of FIG. 2 is not intended to indicate that the gas turbine generator 200 is to include all of the components shown in FIG. 2. Further, any number of additional components may be included within the gas turbine generator 200, depending on the details of the specific implementation. For example, the gas turbine generator 200 may include any suitable types of compressors and valves for controlling the fuel stream 102 and oxidant 104, control systems, coolers, valves and compressors, among others.

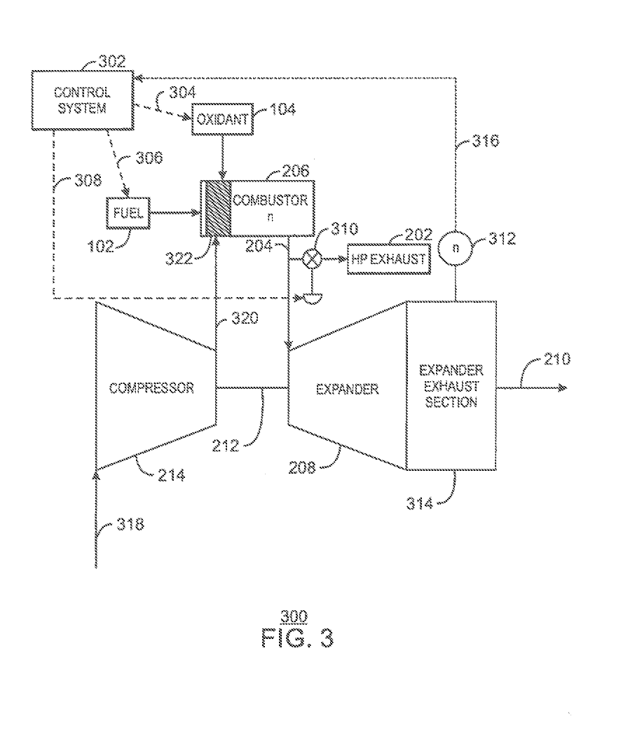

FIG. 3 is a schematic diagram of a gas turbine generator (GTG) 300 illustrating a control system operative to enable a portion 202 of the high pressure exhaust gases 204 from the combustors 206 to bypass the expander turbine 208. Like numbered items are as discussed with respect to FIGS. 1 and 2. The GTG 300 uses a control system 302 to send control signals to each of the devices controlling the mass flowing into and out of the combustors 206. For example, a control signal 304 sent to devices in the oxidant stream 104, such as compressors and valves, can adjust the amount of oxidant fed to the combustors 206. Similarly, a control signal 306 sent to devices in the fuel stream 102, can adjust the amount of fuel fed to the combustors 206. Another control signal 308 may be sent to a valve 310, or other devices, on the high temperature outlet of the combustors 206 to control the portion 202 of the high pressure exhaust gases 204 from the combustors 206 that bypass the expander turbine 208.

A number of sensors 312 can be placed in an expander exhaust section 314 of the gas turbine generator 300. For example, 5, 10, 15, 20, 25, 30, or more sensors 312 may be placed in a ring around the expander exhaust section 314. The number of sensors 312 may be determined by the size of the gas turbine generator 300. The sensors 312 may be any of a number of types, including oxygen sensors, carbon monoxide sensors, temperature sensors, and the like. Examples of oxygen sensors can include lambda and/or wideband zirconia-oxygen sensors, titania sensors, galvanic, infrared, or any combination thereof. Examples of temperature sensors can include thermocouples, resistive temperature devices, infrared sensors, or any combination thereof Examples of carbon monoxide sensors can include oxide-based film sensors such as barium stannate and/or titanium dioxide. For example, a carbon monoxide sensor can include platinum-activated titanium dioxide, lanthanum stabilized titanium dioxide, and the like. Mass flow sensors may be located on the various inlet and outlet lines, for example, to monitor the mass of the fuel stream 102, the oxidant stream 104, and the high pressure exhaust stream 202. The choice of the sensors 312 may be controlled by the response time, as the measurements are needed for real time control of the system. The sensors 312 may also include combinations of different types of sensors 312. The sensors 312 send a data signal 316 to the control system 302.

The control system 302 may be part of a larger system, such as a distributed control system (DCS), a programmable logic controller (PLC), a direct digital controller

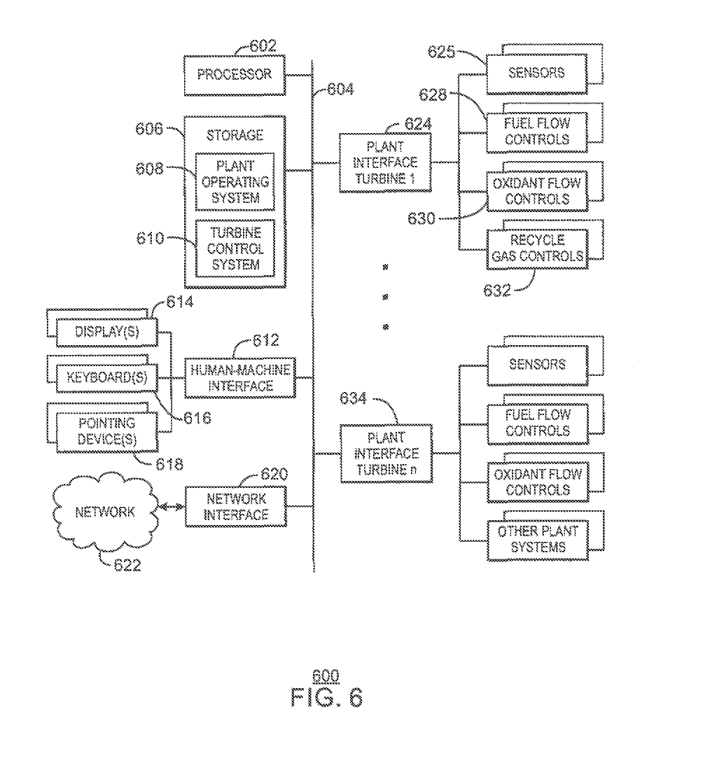

(DDC), or any other appropriate control system. Further, the control system 302 may automatically adjust parameters, or may provide information about the gas turbine generator 300 to an operator who manually performs adjustments. The control system 302 is discussed further with respect to FIG. 6, below.

It will be understood that the gas turbine system 300 shown in FIG. 3, and similar gas turbine systems depicted in other figures, have been simplified to assist in explaining various embodiments of the present techniques. Accordingly, in embodiments of the present techniques, both the oxidant stream 104 and the fuel stream 102, as well as the gas turbine system 300, can include numerous devices not shown. Such devices can include flow meters, such as orifice flow meters, mass flow meters, ultrasonic flow meters, venturi flow meters, and the like. Other devices can include valves, such as piston motor valves (PMVs) to open and close lines, and motor valves, such as diaphragm motor valves (DMVs), globe valves, and the like, to regulate flow rates. Further, compressors, tanks, heat exchangers, and sensors may be utilized in embodiments in addition to the units shown.

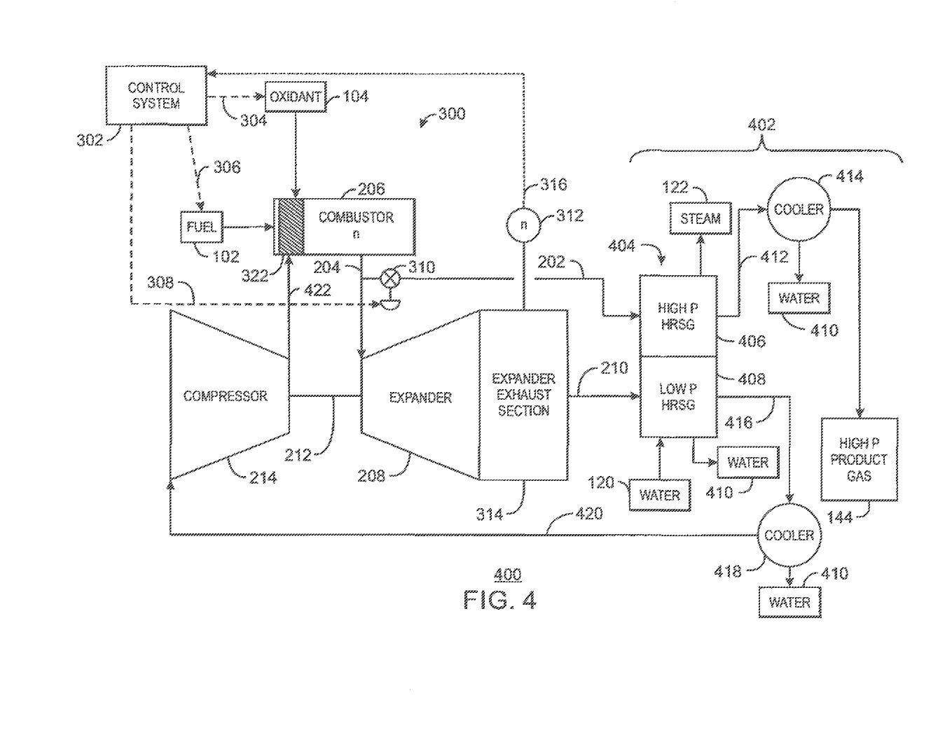

In the embodiment shown in FIG. 3, the compressor 214 may be used to compress a stream 318, such as a recycled exhaust stream. A compressed stream 320 may be injected into a mixing section 322 of the combustor 206, along with the oxidant stream 104 and the fuel stream 102. The compressed stream 320 is not limited to a pure recycle stream, as the compressed stream 320 may provide the oxidant to the combustor 206. The exhaust stream 210 from the expander exhaust section 314 may be used to provide the recycle stream, as discussed further with respect to FIG. 4. The sensors 312 are not limited to the expander exhaust section 314, but may be in any number of other locations in addition to, or instead of, the expander exhaust section 314. For example, the sensors 312 may be disposed in multiple rings around the expander exhaust section 314. Further, the sensors 312 may be separated into multiple rings by the type of sensor 312, for example, with oxygen analyzers in one ring and temperature sensors in another ring. It will be apparent to one of skill in the art that any number of appropriate arrangements may be used. Further, sensors 312 may be placed in the expander turbine 208, and in other parts of the gas turbine generator 300.

FIG. 4 is a schematic of a gas turbine system 400 with a dual exhaust system 402. Like numbered items are as described with respect to FIGS. 1-3. In the dual exhaust system 402, a heat recovery steam generator (HRSG) 404 can be configured to have more than one pressure zone. For example, a high pressure zone 406 can be heated by the portion 202 of the high pressure exhaust gases 204 from the combustors 206 that has bypassed the expander turbine 208. A low pressure zone 408 can be heated by the low pressure exhaust 210 from the expander exhaust section 314 of the expander turbine 208. As described with respect to FIG. 1, the water stream 120 can be boiled in the HRSG 404 to form the steam stream 122. Some water 410 will be condensed from each of the exhaust streams 202 and 210 in the HRSG 404.

A cooled high pressure exhaust gas 412 can be passed through a cooler 414 to condense more water 410, providing the high pressure product gas 144. The product gas 144 can be provided to customers, for example, in a pipeline for use in enhanced oil recovery (EOR) market. In some embodiments, the product gas 144 can be separated into components to provide a CO₂ enriched stream and a CO₂ depleted stream. The CO₂ enriched stream can be sold into the EOR market, while the CO₂ depleted stream can be vented, for example, through a turbine configured to capture the energy of the high pressure stream. In one embodiment, the CO₂ enriched stream is injected into a spent reservoir, or other trap, to provide carbon sequestration.

A low pressure exhaust stream 416 from the HRSG 408 can be sent to a cooler 418 to condense out additional water 410 forming a low pressure recycle stream 420. The low pressure recycle stream 420 can be fed to the compressor 214 to form a compressed recycle stream 422, which is injected into the combustor 206 as a diluent.

The drawing of FIG. 4 is not intended to indicate that the gas turbine system 400 is to include all of the components shown in FIG. 4. Further, any number of additional components may be included within the gas turbine system 400, depending on the details of the specific implementation. For example, the gas turbine system 400 may include any suitable types of compressors and valves for controlling the fuel stream 102, oxidant stream 104, HRSG 404, as well as control systems, coolers, valves and compressors, among others. For example, a steam turbine, as described with respect to FIG. 1, may be used in the gas turbine system 400 for the generation of additional power. Further, the use of a high pressure burner and recycle system is not limited to gas turbine systems, but may also be used in a Rankine cycle generator. In embodiments using a Rankine cycle, the recycle gas may reduce the amount of pollutants released by the system. Further, it may enable more effective carbon sequestration, since the exhaust gas would be concentrated in CO₂. In some embodiments, the use of oxygen separation systems to provide the oxidant 104 may reduce or eliminate the production of NOx, further reducing the pollutants released.

### METHOD FOR REMOVING HIGH PRESSURE GASES

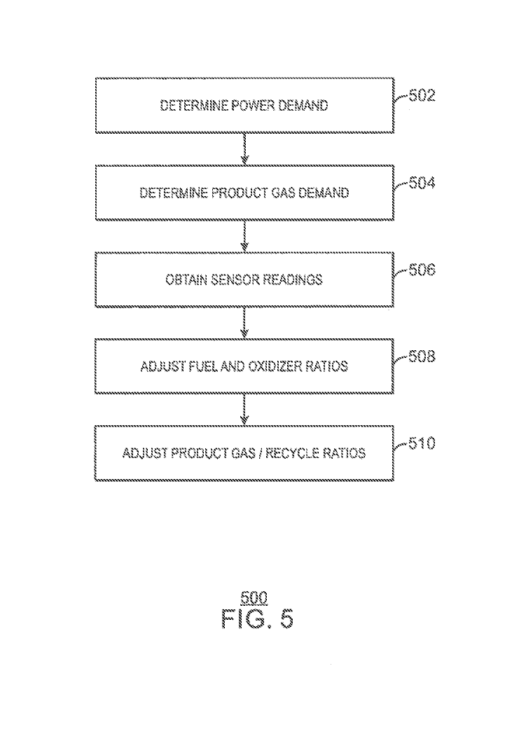

FIG. 5 is a block diagram of a method 500 for operating a power plant to remove at least a portion of gases from a burner prior to an expander turbine. It can be assumed that the power plant has been started before this method 500 begins, and that all of the burners or combustors are using essentially the same mixture or a previous operation point. The method 500 begins at block 502 at which the power demand from the plant is determined The power demand can be used to determine the portion of the exhaust gases that has been removed from the line from the burners or combustors prior to any downstream turbines. Further, the mass of the gas removed will generally correspond to the mass added to the burner or combustor by the addition of oxidant and fuel, in order to maintain mass balance in the recirculation loop. At block 504, the demand for the product gas can be determined If the product gas is being used for a commercial application, such as enhanced oil recovery, the demand may increases under some conditions. In some embodiments, more power may be generated to increase the amount of product gas produced.

At block 506, sensor readings are obtained to determine the amount of unburned fuel or oxygen in the exhaust gases. The total amounts of the oxidant and the fuel added to the combustors can be used to determine the amount of the product gas to be removed after the burner or combustor as product gas. In some embodiments, this also determines the amount of exhaust gas to be sent on to an expander turbine. The measured values can then be used to determine the equivalence ratio or stoichiometry of the burn. The equivalence ratio can be used to adjust the ratio of the oxidant to the fuel at block 508. At block 510, the amount of product gas removed after the burner or combustor may be adjusted to account for any changed in mass added to the combustors in the form of fuel and oxidant.

### CONTROL SYSTEM

FIG. 6 is a block diagram of a plant control system 600 that may be used to control a power plant that is configured to remove a portion of the exhaust gas immediately after a burner or combustor. The control system can adjust the amount of product gas removed, as well as the amounts of the oxidant and fuel provided to a number of combustors in a gas turbine. The control system 600 may be a DCS, a PLC, a DDC, or any other appropriate control device. Further, any controllers, controlled devices, or monitored systems, including sensors, valves, actuators, and other controls, may be part of a real-time distributed control network, such as a FIELDBUS system, in accordance with IEC 61158. The plant control system 600 may host the control system used for each of the gas turbines in a power generation facility.

The control system 600 may have a processor 602, which may be a single core processor, a multiple core processor, or a series of individual processors located in systems through the plant control system 600. The processor 602 can communicate with other systems, including distributed processors, in the plant control system 600 over a bus 604. The bus 604 may be an Ethernet bus, a FIELDBUS, or any number of other buses, including a proprietary bus from a control system vendor. A storage system 606 may be coupled to the bus 604, and may include any combination of non-transitory computer readable media, such as hard drives, optical drives, random access memory (RAM) drives, and memory, including RAM and read only memory (ROM). The storage system 606 may store code used to provide operating systems 608 for the plant, as well as code to implement turbine control systems 610.

A human-machine interface 612 may provide operator access to the plant control system 600, for example, through displays 614, keyboards 616, and pointing devices 618 located at one or more control stations. A network interface 620 may provide access to a network 622, such as a local area network or wide area network for a corporation.

A plant interface 624 may provide measurement and control systems for a first gas turbine system. For example, the plant interface 624 may read a number of sensors 626, such as the sensors 312 described with respect to FIGS. 3 and 4. The plant interface 624 may also make adjustments to a number of controls, including, for example, fuel flow controls 628 used adjust the fuel to the combustors on the gas turbine. Other controls include the oxidant flow controls 630, used, for example, to adjust the oxidant flow to burners or combustors, for example, on a gas turbine. The plant interface 624 may also control recycle gas controls 632 that determine the amount of gas removed from the combustors on a gas turbine versus the amount of gas sent through the expander turbine. Other controls can be used to control other plant systems, such as generators used to produce power from the mechanical energy provided by the gas turbine. The additional plant systems may also include the compressor systems used to provide oxidant to the gas turbine.

The plant control system 600 is not limited to a single plant interface 624. If more turbines are added, additional plant interfaces 634 may be added to control those turbines. Further, the distribution of functionality is not limited to that shown in FIG. 6. Different arrangements could be used, for example, one plant interface system could operate several turbines, while another plant interface system could operate compressor systems, and yet another plant interface could operate generation systems.

While the present techniques may be susceptible to various modifications and alternative forms, the exemplary embodiments discussed above have been shown only by way of example. However, it should again be understood that the techniques is not intended to be limited to the particular embodiments disclosed herein. Indeed, the present techniques include all alternatives, modifications, and equivalents falling within the true spirit and scope of the appended claims.

What is claimed is:

1. A power plant, comprising:
an oxidant system configured to provide a high pressure oxidant stream;
a fuel system comprising a high pressure fuel stream;
a burner configured to combust the high pressure oxidant stream with the high pressure fuel stream to produce a high pressure exhaust gas;
a product gas system configured to extract at least a portion of the high pressure exhaust gas to form a product gas; and
a recycle system configured to return a portion of the high pressure exhaust gas to the burner as a diluent.

2. The power plant of claim 1, comprising a gas turbine system.

3. The power plant of claim 1, comprising a Rankin cycle power plant.

4. A gas turbine system, comprising:
an oxidant system configured to provide a high pressure oxidant stream;
a fuel system configured to provide a high pressure fuel stream;
a combustor configured to combust the high pressure oxidant stream with the high pressure fuel stream to produce a high pressure exhaust gas;
an expander turbine configured to be driven by the high pressure exhaust gas, generating mechanical energy and a low pressure exhaust stream; and
a product gas system disposed between the combustor and the expander turbine, wherein the product gas system is configured to extract at least a portion of the high pressure exhaust gas to form a product gas.

5. The system of claim 4, comprising a generator mechanically coupled to the expander turbine.

6. The system of claim 4, comprising a heat recovery steam generator (HRSG) configured to accept the product gas and boil a water stream to form a steam stream.

7. The system of claim 4, comprising a heat recovery steam generator (HRSG) configured to accept the low pressure exhaust stream and boil a water stream to form a steam stream.

8. The system of claim 4, comprising a heat recovery steam generator comprising:
a high pressure zone configured to form steam using the heat energy in the product gas; and
a low pressure zone configured to form steam using heat energy in the low pressure exhaust stream.

9. The system of claim 4, comprising a recycle system configured to cool and return a portion of the low pressure exhaust stream to the combustor as a diluent.

10. The system of claim 4, comprising a recycle system configured to cool and return a portion of the product gas to the combustor as a diluent.

11. The system of claim 4, comprising a diluent compressor and an exhaust gas recirculation loop adapted to receive the exhaust gas from the expander turbine, wherein the exhaust gas recirculation loop comprises a heat recovery steam generator adapted to generate power, and a cooled exhaust line adapted to provide cooled exhaust gas to the diluent compressor, and wherein the diluent compressor is adapted to provide compressed diluent to the combustor.

12. The system of claim 11, comprising an exhaust gas extraction system disposed between the diluent compressor and the combustor, wherein the exhaust gas extraction system is adapted to extract diluent at elevated pressures.

13. The system of claim 4, comprising a gas separation system configured to separate a carbon dioxide enriched stream from the product gas.

14. A method of extracting a high pressure gas from a power plant, comprising:
providing a fuel to a burner;
providing an oxidant to the burner, wherein an oxidant flow rate is adjusted to provide a substantially stoichiometric ratio of the oxidant to the fuel;
combusting the fuel and the oxidant in the burner to produce an exhaust gas; and
extracting at least a portion of the exhaust gas downstream of the burner and before any other equipment to form a product gas.

15. The method of claim 14, comprising recycling a portion of the exhaust gas to the burner as a diluent.

16. The method of claim 14, comprising:
cooling the product gas to condense water; and
providing the product gas to a pipeline for sale.

17. The method of claim 14, comprising injecting at least a portion of the product gas into a reservoir for carbon sequestration.

18. The method of claim 14, comprising separating a carbon dioxide enriched stream from the product gas.

19. The method of claim 18, comprising injecting the carbon dioxide enriched stream into a reservoir for enhanced oil recovery.

20. The method of claim 18, comprising injecting the carbon dioxide enriched stream into a disposal area for carbon sequestration.

21. The method of claim 14, comprising extracting the product gas from a Rankine cycle power plant.

22. The method of claim 14, comprising adjusting the oxidant flow rate into the burner to adjust the stoichiometry of the burn.

23. The method of claim 14, wherein the burner is a combustor in a gas turbine and the extraction of the portion of the exhaust gas is performed prior to passing the remaining exhaust gas through an expander turbine, wherein the exhaust gas passing through the expander turbine forms a low pressure exhaust gas.
